(19) United States
(12) Patent Application Publication
(10) Pub. No.: US 2005/0134890 A1
(43) Pub. Date: Jun. 23, 2005

(54) Image forming device and a method of selecting emulation automatically thereof

(76) Inventor: Hong-rok Woo, Bucheon-si (KR)

Correspondence Address: STANZIONE & KIM, LLP, 1740 N STREET, N.W., FIRST FLOOR, WASHINGTON, DC, 20036, US

(21) Appl. No.: 11/000,090

(22) Filed: Dec. 1, 2004

(30) Foreign Application Priority Data
Dec. 17, 2003 (KR) 2003-92471

(51) Int. Cl. G06F 15/00

(52) U.S. Cl. 358/1.13

(57) ABSTRACT

A method of selecting automatically an emulation mode includes receiving printing data including a predetermined command through a printer interface from a host, determining whether an emulation mode corresponding to the printing data is set, analyzing commands of the printing data corresponding to emulation modes and calculating a plurality of error values of the emulation modes if the emulation mode is determined to have not been set, and selecting an emulation having a highest use frequency value as a current emulation mode of current printing data if the plurality of error values are the same or a range of error values is in excess of a preset allowable error range, and selecting an emulation having a lowest error value as the current emulation mode of the current printing data when the plurality of the error values are not the same or the range of the error values is not in excess of a preset allowable error range. The emulation mode can be selected more precisely because the emulation is selected according to a use frequency of the emulation mode in a printing process.

### CROSS-REFERENCE TO RELATED APPLICATIONS

This application claims the benefit of Korean Patent Application No. 2003-92471 filed on Dec. 17, 2003, in the Korean Intellectual Property Office, the disclosure of which is incorporated herein by reference.

### BACKGROUND OF THE INVENTION

1. Field of the Invention

The present general inventive concept relates to an image forming device and a method of selecting emulation automatically thereof, and more particularly, to an image forming device and a method of selecting an emulation thereof by automatically switching an emulation mode based on a frequency of using the emulation for actual printing.

2. Description of the Related Art

An image forming device, such as a printer, a copier, and a facsimile, operates to output an image corresponding to original input image data to a recording medium, such as a printing paper.

Hereinbelow, the printer is described as one example of the image forming device. A printer standard of the printer supports capital and small letters of alphabets, numbers, symbols, and a twice enlargement of them in horizontal and vertical directions. Therefore, in order to support a diverse and colorful printout, various printing methods are used together with the printer standard according to manufactures.

Here, ‘emulation’ refers to a certain function of a general printer which is associated with processing data in a variety of code systems into a certain form printable through the general printer.

A printer control language (PCL), a page description language (PDL), a KS/KSSM emulation, and so on are now widely used, and a graphic device interface (GDI) emulation using an operating system (OS) is also used.

According to conventional methods of automatically switching an emulation mode, it is difficult to choose the emulation mode suitable for printing data due to a similarity among printer languages.

Therefore, it can not be guaranteed that the emulation mode is precisely selected since an emulation process is automatically performed based on a certain emulation mode set in advance in the printer.

### SUMMARY OF THE INVENTION

In order to solve the above and/or other drawbacks and problems, it is an aspect of the present general inventive concept to provide an image forming device and a control method thereof which can increase an accuracy in switching an emulation mode by selecting a most frequently used emulation mode in actual printing as the emulation mode of a printing process when it is difficult to precisely decide an emulation suitable for printing data.

Additional aspects and advantages of the present general inventive concept will be set forth in part in the description which follows and, in part, will be obvious from the description, or may be learned by practice of the general inventive concept.

The above and/or other aspects of the present general inventive concept may be achieved by providing a method of automatically switching an emulation mode, the method including receiving printing data including a predetermined command through a printer interface from a host, determining whether an emulation mode corresponding to the printing data is set, analyzing the commands of the printing data corresponding to emulation modes and calculating a plurality of error values of each emulation mode if the emulation mode is determined to have not been set, selecting an emulation mode having a highest use frequency value as a current emulation mode of a printing process if the plurality of error values are the same or a range of the error values is in excess of a preset allowable error range, and selecting an emulation mode having a lowest error value as the current emulation mode of the printing process when the plurality of the error values are not the same or the range of the error values is not in excess of the preset allowable error range.

In an aspect of the present general inventive concept, the error values may be obtained by dividing the number of commands corresponding to the emulation mode by the total number of commands.

In another aspect of the present general inventive concept, the number of commands corresponding to the emulation mode and the total number of commands may be calculated based on a command analysis program.

In yet another aspect of the present general inventive concept, if a certain emulation mode is selected, a use frequency value of the selected emulation mode may be controlled to be increased by one point.

In still another aspect of the present general inventive concept, the method of automatically switching the emulation mode may further include performing the emulation in a predetermined emulation mode, if the predetermined emulation mode corresponding to the printing data is set in advance.

The above and/or other aspects of the present general inventive concept may also be achieved by providing an image forming device including a controlling part to receive printing data including a certain command through a printer interface from a host, to determine whether a certain emulation mode corresponding to the printing data is set in advance, and to output the printing data if no emulation mode is set in advance, a printing data analysis part to analyze commands of the print data corresponding to the certain emulation mode to calculate a plurality of error values of emulation modes, an emulation mode selection part to select an emulation having a highest use frequency as a current emulation mode of a current printing process of printing current printing data if the plurality of error values are the same or a range of the error values is in excess of the predetermined and allowable range of errors, and to select an emulation having a lowest error value as the current emulation mode of the printing process when the plurality of error values are not the same or the range of the error values are not in excess of the predetermined and allowable range of errors, an emulation process part to perform the emulation according to the selected emulation mode to output bitmap image data corresponding to the received printing data, and a printing part to receive the bitmap image data to print.

In an aspect of the present general inventive concept, the error values may be obtained by dividing the number of commands corresponding to the emulation mode by the total number of commands.

In another aspect of the present general inventive concept, the number of command corresponding to the emulation mode and the total number of commands may be calculated based on a command analysis program.

In another aspect of the present general inventive concept if a certain emulation mode corresponding to the printing data is set in advance, the control part may transmit the printing data to the emulation process part to perform the emulation according to the preset emulation mode.

In another aspect of the present general inventive concept if the emulation mode is selected, the control part may control to increase a use frequency value of the selected emulation mode by one point.

In another aspect of the present general inventive concept, the image forming device may further include a storing part to store a use frequency value of the emulation mode in real time basis and to provide the use frequency value of the emulation mode in response to a request of the emulation mode selection part.

The storing part may be a Non Volatile RAM NVRAM.

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIG. 1 is a block diagram illustrating an image forming device according to an embodiment of the present general inventive concept; and

FIG. 2 is a flow chart illustrating a process of switching automatically an emulation mode in an image forming device according to another embodiment of the present general inventive concept.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures. The matters defined in the description such as a detailed construction and elements are nothing but the ones provided to assist in a comprehensive understanding of the invention. Thus, it is apparent that the present invention can be carried out without those defined matters. Also, well-known functions or constructions are not described in detail since they would obscure the invention in unnecessary detail.

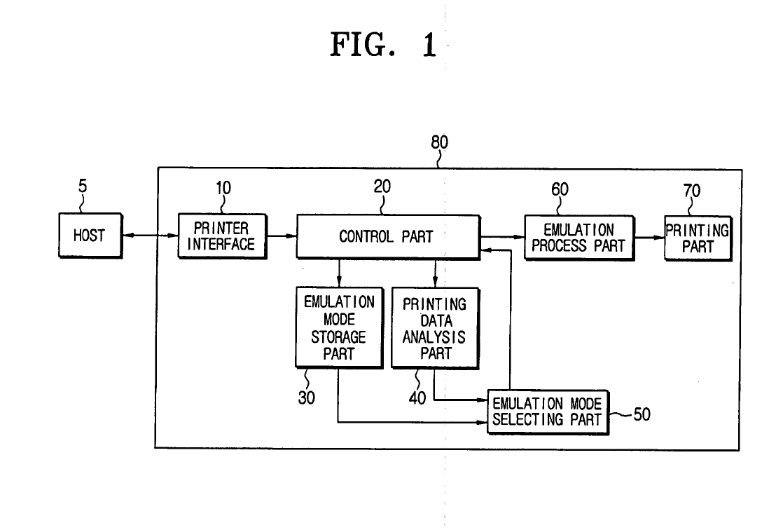

FIG. 1 is a block diagram illustrating an image forming device 80 according to an embodiment of the present general inventive concept.

Referring to FIG. 1, the image forming device 80 may include a printer interface 10, a control part 20, an emulation mode storing (storage) part 30, a printing data analysis part 40, an emulation mode selecting part 50, an emulation process part 60 and a printing part 70.

The control part 20 can receive printing data including information of a printing condition, such as a printing direction and/or the number of sheets of printing paper, through the printer interface 10 from a host 5. If a certain emulation mode corresponding to the printing data is set by a user, the control part 20 can transmit the printing data to the emulation process part 60, and thus, the emulation process part 60 can perform an emulation according to the received printing data and the set emulation mode.

The control part 20 can transmit the printing data to the printing data analysis part 40 if the emulation mode is not set by a user.

The control part 20 can check the emulation mode being in use and increases a use frequency (use frequency value) of the checked emulation mode by one point.

The emulation mode storing part 30 can receive and store therein the use frequency value of each emulation mode from the control part 20 in real time basis. The emulation mode storing part 30 may be realized using a Non Volatile RAM (NVRAM).

The printing data analysis part 40 can analyze a control code of the received printing data to calculate an error value of each emulation mode and can transmit the calculated error value to the emulation mode selecting part 50.

The error value of the each emulation mode may indicates a relationship between a frequency of the each emulation mode and a total frequency of total emulation modes or a difference between the number of printing processes of the printing data according to the each emulation mode and the number of printing processes of the printing data in the image forming device 80.

The emulation mode selecting part 50 can select an emulation mode having a lowest error value as a current emulation mode for a present (current) printing process of printing current printing data, and can transmit information about the selected emulation mode to the emulation process part 60.

The emulation mode selecting part 50 can analyze the use frequency value of each emulation mode stored in the emulation mode storing part 30, if error values of the emulation modes are the same or a range of the error values is in excess of an allowable and predetermined amount. An emulation mode having a highest use frequency value can be selected as the current emulation mode, and therefore, information of the emulation mode of the highest use frequency can be transmitted to the control part 20.

When the current emulation mode is determined, the emulation process part 60 can receive the printing data from the control part 20 to process text or image data according to the determined current emulation mode, and can transmit the print data in bitmap image data to the printing part 70 with a resolution set suitably for the printing process.

The printing part 70 can start the printing process based on the bitmap image data being input from the emulation process part 60.

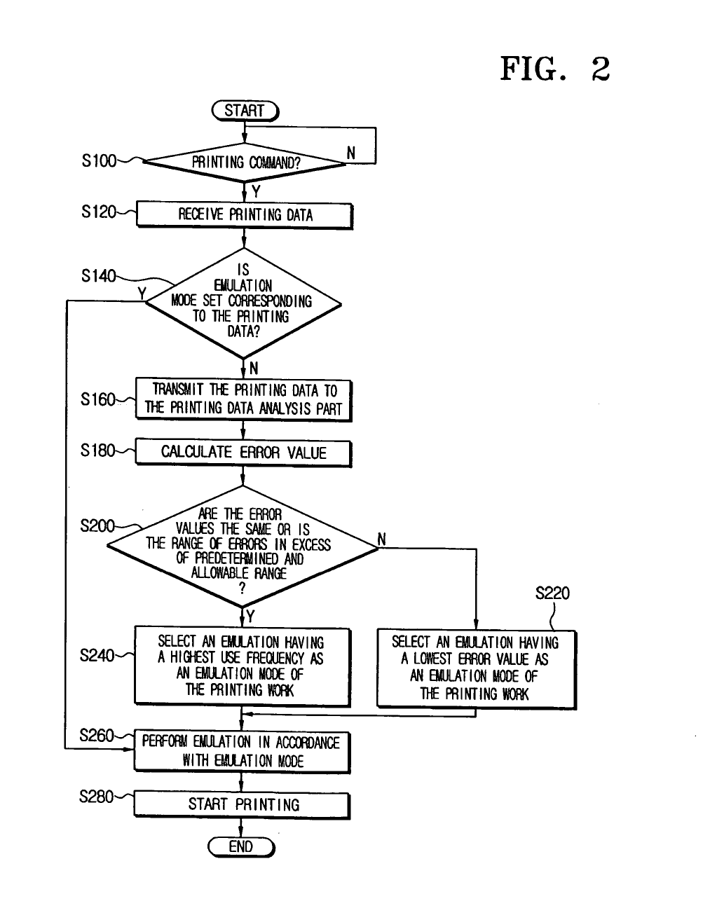

FIG. 2 is a flowchart illustrating a method of switching automatically an emulation mode in the image forming device 80 according to another embodiment of the present general inventive concept will be in detail described.

Referring to FIGS. 1 and 2, in response to a user's printing request through an inputting part of the host 5, the host 5 can generate the printing command (S100).

The control part 20 can receive the printing data including information of the printing condition, such as the printing direction and/or the number of sheets of printing paper, through the printer interface 10 from the host 5 (S120).

The control part 20 can determine whether a certain emulation mode corresponding to the printing data is set by a user (S140).

If the certain emulation mode corresponding to the printing data is set, the control part 20 can analyze the header information of the printing data in the set emulation mode, and can transmit the printing data to the emulation process part 60. The emulation process part 60 can perform image processing the printing data into a printable image, such as a bitmap image, in accordance with the analyzed information (S260).

If the certain emulation mode corresponding to the printing data is not set by the user, the control part 20 can transmit the printing data to the printing data analysis part 40 (S160).

The printing data analysis part 40 can analyze the printing data of different code systems to calculate an error value, which provides a reference to determine a most suitable emulation for the printing data (S180). The process of calculating the error value is described below.

More specifically, a so-called sample area corresponding to a front part of the printing data is analyzed, and a size of the sample area is generally about 512 byte. The sample area may include a command of which length may vary.

The printing data analysis part 40 can use a command analysis program to analyze the command of the sample area. As an example of a command analysis process of the command analysis program, two kinds of emulation, for example, a printer control language (PCL) and a postscript language (PS), are assumed to be set in the image forming device 80. An emulation for the PCL can be referred to as a first emulation mode, and an emulation for the PS can also be referred to as a second emulation mode. The emulation mode selecting part 50 can use the command analysis program to analyze the total number of the commands included in the printing data, and particularly, the number of commands corresponding to the PCL. If the total number of the commands is 8 and the number of commands corresponding to the PCL is 4, the error value of the emulation mode for the PCL can be calculated by dividing the number of commands not corresponding to the PCL by the total number of the commands. At this time, the error value is (8−4)/8=0.5.

Next, it is determined as to whether the printing data contains the command corresponding to the PS. If the total number of the commands is 12 and the number of commands corresponding to the PS is 3, the error value can be (12−3)/12=0.75.

Error values, which are calculated at the printing data analysis part 40 as described above, can be input to the emulation mode selecting part 50.

The emulation mode selecting part 50 can compare the respective error values calculated in the printing data analysis part 40 to determine whether the error values are the same or a range of the error values is in excess of an allowed range which was set in advance by a user or a manufacturer of the image forming device (S200).

When the range of error values is in excess of the predetermined and allowed range, this indicates that the total number of the commands is below the number of preset commands and the calculated error values are not reliable. For example, if the total number of the commands is 2 and the number of commands related to the emulation corresponding to the printing data is 1, error reliability is low due to few samples of the total number of the commands being calculated.

If the error values are not the same and the error range is in the predetermined and allowable error range, the emulation mode selection part 50 can select an emulation mode having a least error value as the current emulation mode of the printing process (S220). In the above example, the emulation mode for the PCL having a little error value is selected as the current emulation mode for the printing process of the received printing data.

If the error values are the same or the error range is in excess of the predetermined and allowable error range, the emulation mode selection part 50 can select an emulation mode having a highest use frequency as the emulation mode of the printing process (S240).

Each emulation used in the printing process can be checked by a use frequency check program of the control part 20, and the use frequency value thereof can be accordingly updated and stored in the emulation mode storing part 30. The emulation mode selection part 50 can receive the use frequency value of each emulation stored in the emulation mode storing part 30 to compare the use frequency value with a reference, and can select an emulation mode having a highest use frequency as the emulation mode of the printing process.

If a certain emulation mode is selected in the emulation mode selection part 50, the selected emulation mode information can be input to the control part 20. The control part 20 can transmit the printing data to the emulation process part 60 so as to perform the emulation in the selected emulation mode. The control part 20 can control the use frequency value of the selected emulation mode to increase by one point by use of the use frequency check program, and can store the updated value (increased use frequency value) in the emulation mode storing part 30.

The emulation process part 60 can process the received printing data using the emulation (S260). Accordingly, text or image data can be processed, and bitmap image data thereof can be transmitted to the printing part 70 in accordance with the resolution for printing.

The printing part 70 can start the printing process based on the bitmap image data input from the emulation process part 60 (S280).

As described above, the emulation mode which are the most frequently used can be selected and therefore, the printing process can be performed more efficiently.

According to the embodiment of the present general inventive concept, an emulation mode can be selected more efficiently because an emulation is selected according to a use frequency in the actual printing process.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

1. A method of selecting automatically an emulation mode, the method comprising:
receiving printing data including a predetermined command through a printer interface from a host;
determining whether an emulation mode corresponding to the printing data is set;
analyzing commands of the printing data corresponding to emulation modes and calculating a plurality of error values of the emulation modes if the emulation mode is not set; and
selecting an emulation mode having a highest one of use frequency values as a current emulation mode of current printing data if the plurality of error values are substantially the same or a range of the error values is greater than a preset allowable error range, and selecting an emulation mode having a lowest one of the error values as the current emulation mode of the printing process when the plurality of error values are not the same or the range of the error values is not greater than the preset allowable error range.

2. The method as claimed in claim 1, wherein the error values are obtained by dividing the number of commands of the printing data corresponding to the emulation mode by the total number of commands of the printing data.

3. The method as claimed in claim 2, wherein the number of commands of the printing data corresponding to the emulation mode and the total number of commands of the printing data are calculated based on a command analysis program.

4. The method as claimed in claim 1, wherein if the total number of commands of the printing data is below a preset command range, the error range is determined to be greater than the predetermined and allowable error range.

5. The method as claimed in claim 1, wherein if a certain emulation mode is selected as the current emulation mode, a use frequency value of the selected emulation mode is controlled to be increased by a predetermined value as the one of the used frequency values corresponding to the selected emulation mode.

6. The method as claimed in claim 1, further comprising:
performing an emulation according to the predetermined emulation mode if the emulation mode corresponding to the printing data is set in advance.

7. An image forming device, comprising:
a controlling part to receive printing data including a certain command through a printer interface from a host, to determine whether a certain emulation mode corresponding to the printing data is set in advance, and to output the printing data if there is no emulation mode set in advance;
a printing data analysis part to analyze commands of the printing data corresponding to emulation modes to calculate a plurality of error values of respective emulation modes;
an emulation mode selection part to select an emulation mode having a highest one of use frequency values as a current emulation mode of a current printing process of current printing data if the plurality of the error values are the same or a range of the error values is greater than a predetermined and allowable range of errors, and selecting an emulation mode having a lowest one of the error values as the current emulation mode of the printing process when the plurality of the error values are not the same or the range of the error values is not greater than the preset allowable error range;
an emulation process part to perform an emulation in the selected emulation mode to output bitmap image data; and
a printing part to print the bitmap image data.

8. The device as claimed in claim 7, wherein the error values are obtained by dividing the number of commands of the printing data corresponding to the emulation mode by the total number of commands of the printing data.

9. The device as claimed in claim 7, wherein the number of command of the printing data corresponding to the emulation mode and the total number of commands of the printing data are calculated based on a command analysis program.

10. The device as claimed in claim 7, wherein if the total number of commands is below a preset command range, the error range is determined to be greater than the predetermined and allowable error range.

11. The device as claimed in claim 7, wherein if the certain emulation mode corresponding to the printing data is set in advance, the control part transmits the printing data to the emulation process part to perform the emulation in the preset emulation mode.

12. The device as claimed in claim 7, wherein if the emulation mode is selected, the control part controls to increase a use frequency value of the selected emulation mode by a reference value.

13. The device as claimed in claim 7, further comprising:
a storing part to store the use frequency values of the emulation modes in real time basis and to provide the use frequency values of the emulation modes in response to a request of the emulation mode selection part.

14. The device as claimed in claim 13, wherein the storing part is a non-volatile RAM (NVRAM).

15. A method of an image forming device, the method comprising:
storing a first use frequency value of a first emulation mode and a second use frequency value of a second emulation mode;
generating a first error value of the first emulation mode and a second error value of the second emulation mode; and
selecting one of the first and second emulation modes as a current emulation mode with respect to current printing data according to the first and second use frequency values and at least one of the first and second error values and a range of the first and second error values.

16. The method as claimed in claim 15, further comprising:
printing the current printing data according to an emulation corresponding to the selected one of the first and second emulation modes.

17. The method as claimed in claim 15, wherein the selecting of the one of the first and second emulation modes comprises:
selecting the first emulation mode as the current emulation mode when the first use frequency value is higher than the second use frequency value, and the range of the first and second error values is greater than a reference range.

18. The method as claimed in claim 15, wherein the selecting of the one of the first and second emulation modes comprises:
selecting the second emulation mode as the current emulation mode when the second error value is lower than the second error value, and the range of the first and second error values is not greater than a reference range.

19. An image forming device comprising:
an emulation mode storing part to store a first use frequency value of a first emulation mode and a second use frequency value of a second emulation mode:
a printing data analysis part to generate a first error value of the first emulation mode and a second error value of the second emulation mode; and
an emulation mode selecting part to select one of the first and second emulation modes as a current emulation mode with respect to current printing data according to at least one of the first and second error values and a range of the first and second error values.

20. A method of an image forming device, the method comprising:
analyzing printing data to calculate error values of emulation modes;
generating use frequency values of the emulation modes used in printing processes; and
selecting one of the emulations as a current emulation mode with respect to current printing data according to the use frequency values and at least one of the error values and a range of the error values.

21. The method as claimed in claim 20, further comprising:
printing the current printing data according to the selected current emulation mode when a preset emulation mode corresponding to the current printing data is not set.

22. The method as claimed in claim 20, wherein the selecting of the one of the emulations comprises:
selecting the one of the emulations as the current emulation mode when the error values are substantially the same as a reference value.

23. The method as claimed in claim 20, wherein the selecting of the one of the emulations comprises:
selecting the one of the emulations as the current emulation mode when the range of the error values is greater than a reference range.

24. The method as claimed in claim 20, wherein the selecting of the one of the emulations comprises:
selecting an emulation having a highest one of the use frequency values as the current emulation mode use frequency value according to the error values and the range of the error values.

25. The method as claimed in claim 20, wherein the selecting of the one of the emulations comprises:
selecting an emulation having a highest one of the use frequency values as the current emulation mode to print the current printing data when the error values are substantially the same and the range of the error values is greater than a reference range.

26. The method as claimed in claim 20, wherein the selecting of the one of the emulations comprises:
selecting an emulation having a lowest one of the error values as the current emulation mode to print the current printing data when the error values are not substantially the same and the range of the error values is not greater than a reference range.

27. An image forming device, comprising:
a printing data analysis part to analyze printing data to calculate error values of emulation modes;
an emulation mode storing part to store use frequency values of the emulation modes used in printing processes; and
an emulation mode selecting part to select one of the emulations as a current emulation mode with respect to current printing data according to the use frequency values and at least one of the error values and a range of the error values.

28. The device as claimed in claim 27, further comprising:
an emulation process part to print the current printing data according to the selected current emulation mode when a preset emulation mode corresponding to the received printing data is not set.

29. The device as claimed in claim 27, wherein the emulation mode selecting part selects an emulation having a highest one of the use frequency values as the current emulation mode to perform a printing process of the current printing data when the error values are substantially the same and the range of the error values is greater than a reference range.

30. The device as claimed in claim 27, wherein the emulation mode selecting part selects an emulation having a lowest one of the error values as the current emulation mode to print the current printing data when the error values are not substantially the same and the range of the error values is not greater than a reference range.
